(19) United States
(12) Patent Application Publication
(10) Pub. No.: US 2003/0209822 A1
(43) Pub. Date: Nov. 13, 2003

(54) Recycling of used automobile tires in to shoe soles

(76) Inventor: Vinod Kumar Soni, Cincinnati, OH (US)

Correspondence Address: VINOD KUMAR SONI, 5766 GLOW COURT, CINCINNATI, OH, 45238, US

(21) Appl. No.: 10/085,238

(22) Filed: May 7, 2002

(51) Int. Cl. B29D 31/50

(52) U.S. Cl. 264/36.14

(57) ABSTRACT

Rescuing vast junk of Used Automobile Tires from Environment without burning the tires, as the burning results in too many poisonous gases. The use of Old Used Automobile Tires into Shoe Soles would highly contribute towards Saving the Environment.

### BACKGROUND OF INVENTION

Rescuing the huge junk of used automobile tires from Planet Earth has taken a complicated shape. Recycling by making reclaimed Rubber after burning the tires result in too much poisonous gases due to the chemicals involved in the rubber hence adds tremendous negative to the Environment. Recycling used automobile tires into shoe soles would save the cost and protect our Environment, as we are going to use the tire in the same form just by cutting it into the required size of shoe sole. A Wonder Step towards Pollution free days ahead.

### BRIEF SUMMARY OF THE INVENTION

Infinite number of used automobile tires on Planet Earth can tell us the vastness of the problem. More tires we would burn to recycle into reclaim rubber, more poisonous gases go to the Environment. Environment is a real hot topic of this century and no one can afford to ignore it. Day-by-Day, our breathing air is getting more poisonous. So recycling used tires into shoe soles by direct cutting and shaping into specified sizes is a concrete step towards saving Environment, saving cost as we would be having excellent long life soles at throw away price. This invention is a total win win situation for human beings.

### OBJECT OF INVENTION

Rescuing huge junk of used automobile tires from Planet Earth in a useful manner for human beings, that too without making any harm to Environment, which the old ways of burning the tires to make reclaim rubber could not do.

### BRIEF DESCRIPTION OF THE DRAWINGS

FIG. 1. Shows the General view of a Tire.

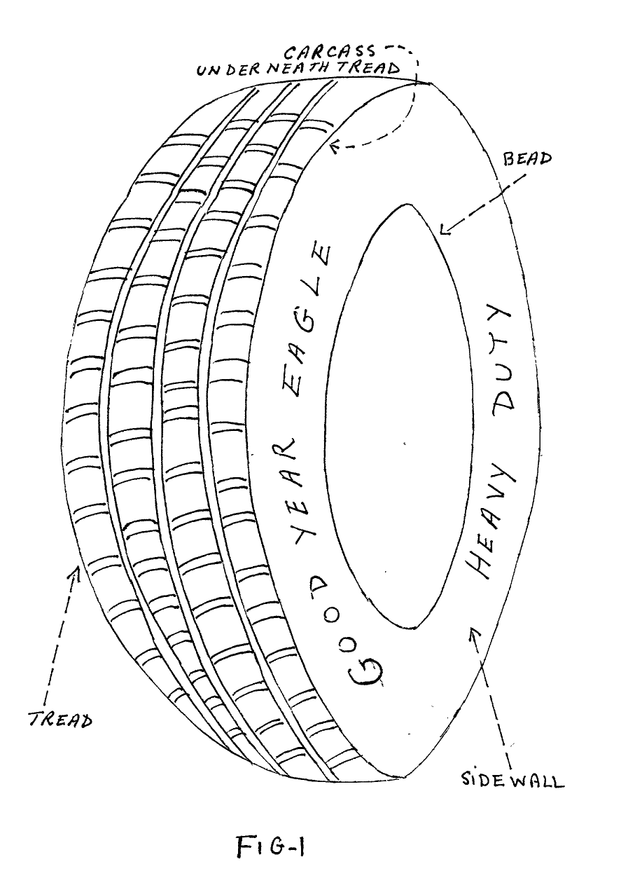

Sidewall: Flexible portion on the both sides of a Tire.

Bead: Bundle of Metallic wires to hold along the Rim.

Tread: The portion that goes in contact with road.

Carcass. Portion underneath the tread.

NOTE We remove the Rubberized tread portion of the tire from the base carcass with Mechanical knife and use the Carcass portion for different type of shoe soles. The separated rubber of Tread portion is also used in developing more thickness of Heels or Shoe soles as per requirement.

FIG. 2. Shows ready Shoe sole with heel attached with the specified size of upper.

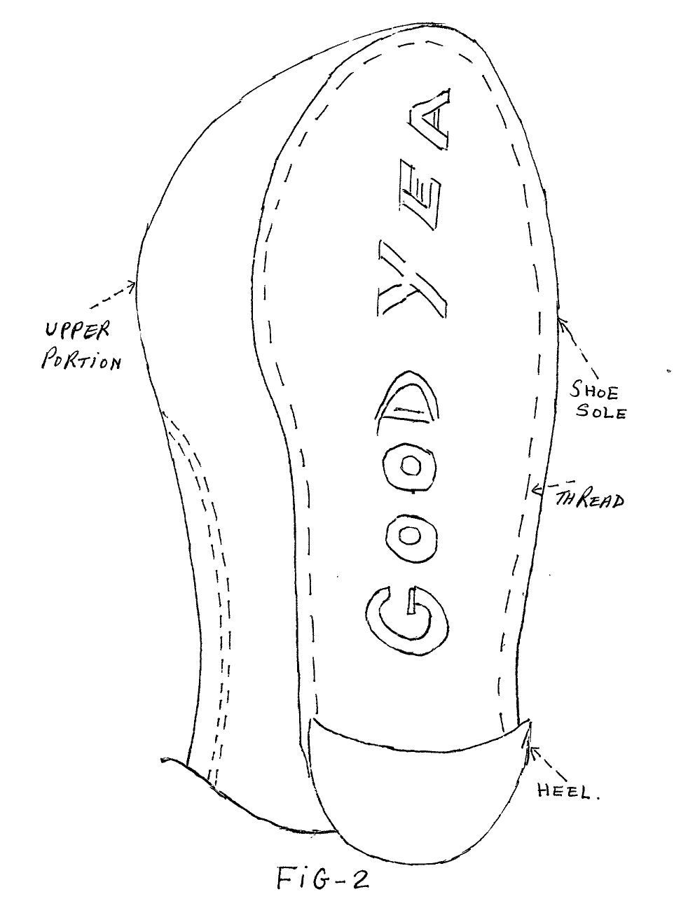

FIG. 2A. Shows the side wall portion separated out on cutting with sharp edged mechanical knives.

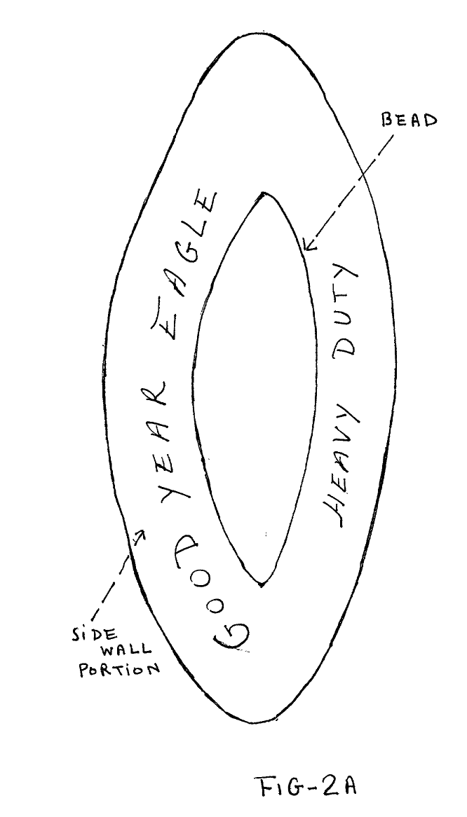

FIG. 2B. Metallic wire bead portion separated out from the sidewall portion with sharp mechanical knives to make the sidewall portion ready to be shaped into shoe sole.

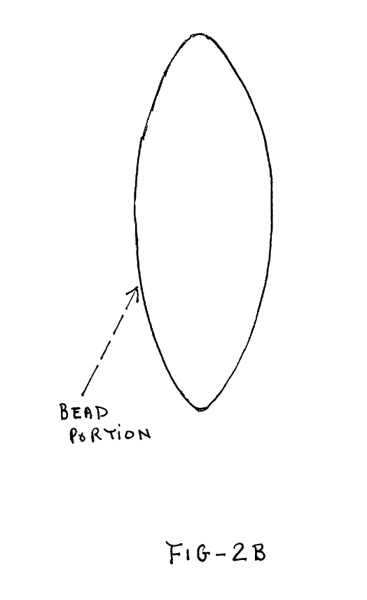

FIG. 2C. Sidewall area further shaped with mechanical knives into specified size ofShoe sole.

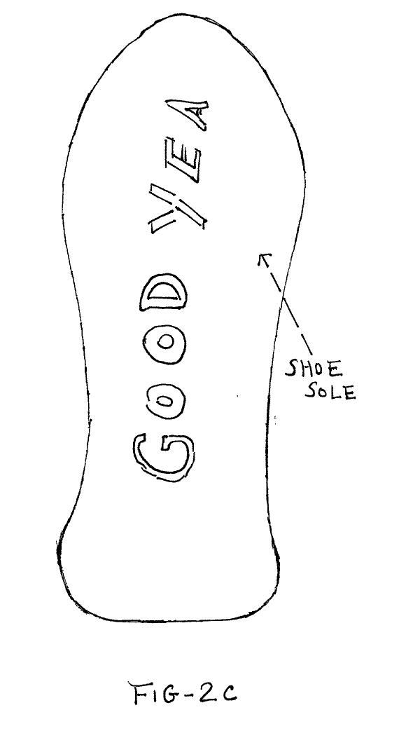

FIG. 2D. The specified size shoe sole piece is stitched to the already shaped leather Upper of the same size with heavy-duty needles and thread.

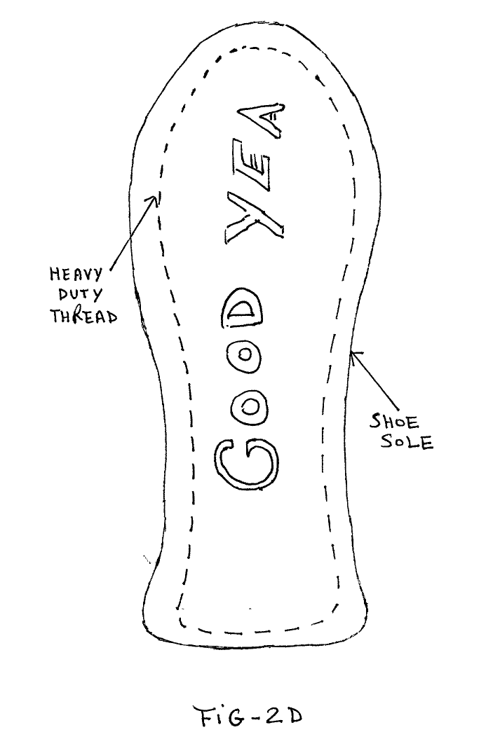

FIG. 2E. Heel portion cut out of the sidewall as per the specified required size by sharp mechanical knives.

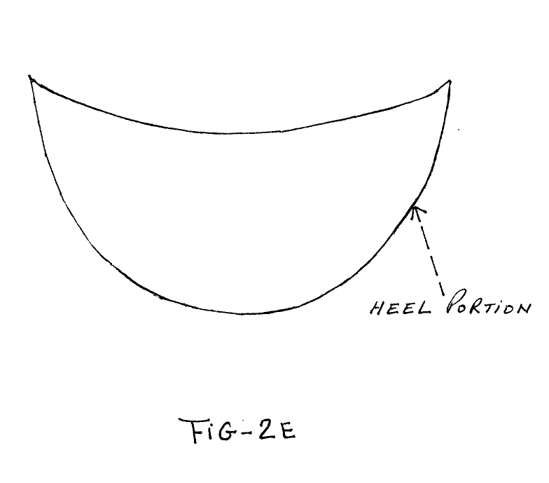

FIG. 2F. The specified size of heel is attached to the sole with the help of strong rubber adhesives, after giving enough drying time to the adhesive on shoe sole portion underneath the heel and on the heel portion going in contact with the sole portion.

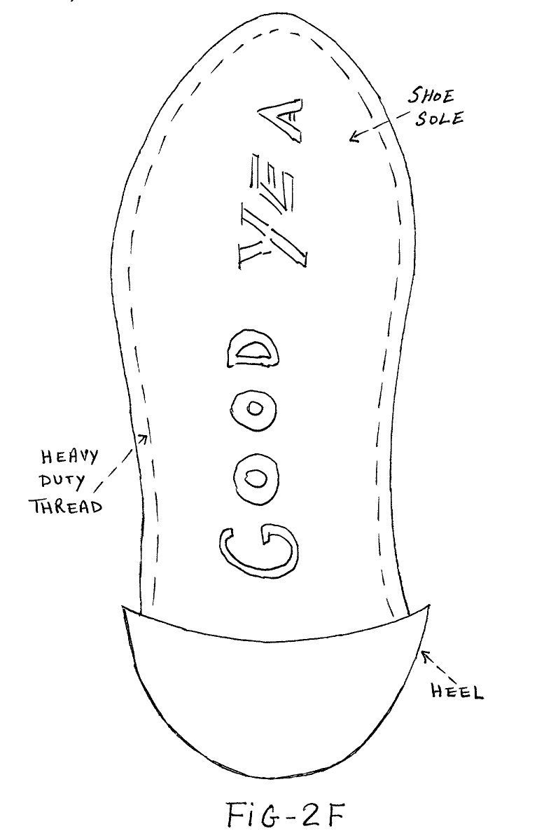

### DETAILED DESCRIPTION OF THE INVENTION

This invention would add to the routes of Pollution free days ahead for Human beings by ignoring the old ways of burning the infinite number of old tires on this planet Earth that directly adds poisonous gases to the air we breathe. In place of burning tires to make reclaim rubber, we would directly cut the old tires into different parts known as Sidewall portion, Tread portion and Bead portion. Sidewall portion would be directly cut with Mechanical knives into specified sizes of Shoe Soles. Tread portion would be converted into Carcass portion after removing the thick rubber of Tread with Mechanical knives and this Carcass portion is further cut into specified sizes of shoe soles with mechanical knives. Specified sizes of Heels are cut out of Sidewall portions or Carcass portions. Thick layer of Rubber removed in the shape of Tread are also used to add thickness to the Heel or Sole portion wherever required.

Now the specified size of sole created by the above method is adjusted with strong adhesives underneath the leather shoe upper already shaped on mould for six hours. Drying time for the adhesives is one hour in normal temperature and need strict precaution against moisture. Now we remove the mould out of the leather Upper and stitch the sole with the Upper portion with the help of heavy duty thread and needles.

Then the specified size of Heel is fixed on the sole with the help of strong adhesives after giving due drying time as mentioned above. This makes an excellent Shoe with Shoe sole of Long Life, Great Insulation and Great Comfort.

1. I claim the invention for the recycling of used automobile tires into shoe soles:
